(19) United States
(12) Patent Application Publication
(10) Pub. No.: US 2002/0184145 A1
(43) Pub. Date: Dec. 5, 2002

(54) Methods and system for integrating XML based transactions in an electronic invoice presentment and payment environment

(75) Inventors: Michael Anthony Sijacic, San Francisco, CA (US); Michal Chmielewski, San Jose, CA (US); Noel R. Gonsalves, Fremont, CA (US)

Correspondence Address: FINNEGAN, HENDERSON, FARABOW, GARRETT &, DUNNER LLP, 1300 I STREET, NW, WASHINGTON, DC, 20006, US

(73) Assignee: Sun Microsystems, Inc.

(21) Appl. No.: 09/867,649

(22) Filed: May 31, 2001

(51) Int. Cl. G06F 17/60

(52) U.S. Cl. 705/40

(57) ABSTRACT

A system and method for performing XML integration strategies in an server based system is disclosed. A requesting entity generates a request message for information managed by a server system. The request message is passed to a communications servlet operating within the server system. The servlet ensures the request message is in XML format and includes a transformer tag that designates the type of corresponding response message required. The XML servlet validates the request message to ensure it conforms to a particular document type definition. If so, the request message is parsed into an object model, and transferred to a manager process for processing the request. Then, the manager process produces a response message corresponding to the request massage. The response message is eventually passed to a transformer where the transformer tag is checked to determine what type of response message is required by the requesting entity. Once determined, the transformer converts the response message into the appropriate format, and the message is made available in a format that is compatible with the requesting entity.

### FIELD OF THE INVENTION

This invention relates to electronic invoice presentment and payment environments and, more particularly, to methods, systems and articles of manufacture for performing XML based transactions in a business-to-business electronic invoice presentment and payment environment.

### BACKGROUND OF THE INVENTION

Businesses charge for goods and/or services that they provide and customers who receive these goods and/or services pay for them. Although the cost of providing these goods and/or services are typically associated with a business' operating costs, the transaction costs associated with managing billing operations are sometimes overlooked.

Currently, businesses spend millions of dollars to process account information and bill customers. Billing systems and processes are predominately paper based and are conducted through human interaction. The billing costs associated with paper, handling and postage, not to mention the availability of funds, increases with each new customer a business serves.

To offset the costs of managing billing operations, businesses have entertained the implementation of business-to-customer (B2C) Internet bill presentment and payment (IBPP) systems. By implementing an IBPP system, businesses allow customers to view, store and pay recurring bills using a browser, e-mail, or personal financial management software. Accordingly, the IBPP market is growing in popularity due to its inherent benefit of reducing the costs associated with billing operations.

Based on the success of business-to-customer (B2C) based IBPP systems, businesses have contemplated applying the IBPP concepts to business-to-business (B2B) markets. Through this foresight, electronic invoice presentment and payment (EIPP) systems have evolved. The B2B EIPP market represents a significant departure from the B2C IBPP market. As with their counterpart, B2B EIPP systems allow businesses to save money through less paper work. However, in addition to these benefits, B2B EIPP systems also allow businesses to have greater control over and insight into the entire invoice process, including dispute handling and associated bill recalculations prior to payment.

Although conventional EIPP systems give businesses versatility in processing invoices, they do not operate at acceptable speeds. In a B2B environment, discrete goods and services are generally invoiced upon ordering, delivery, or some other event that is independent of a billing cycle. This means that an EIPP system must be capable of handling data feeds at near real-time as opposed to a monthly cyclical feed.

Furthermore, in B2B environments, both purchasers and providers require a method for translating data from an EIPP system and placing it directly on their internal systems. In order to accomplish this, the EIPP system would have to address not only data formats, but also transmission types.

To address these problems, conventional EIPP systems have implemented electronic data interchange (EDI) methods to handle transactions between businesses. EDI works by providing a collection of standard message formats and element dictionary in a simple way for businesses to exchange data via any electronic messaging service. However, this method is cumbersome and financially out of reach to all but the very largest companies.

### SUMMARY OF THE INVENTION

It is therefore desirable to have a method and system that employ a data representation language, such as eXtensible Markup Language (XML), with data conversion and mapping facilities to enable efficient and versatile data exchange between a billing system and its customers.

Methods, systems and articles of manufacture consistent with the present invention allow requesting entities to request and obtain information from an EIPP server system regardless of the type of device or software used to generate the request. In one implementation consistent with the present invention, an XML servlet is implemented within a billing manager process that collects request messages that have been converted into a particular XML format usable by the servlet. The request message includes a transformation tag that designates the required format of a response message associated with the request message.

The XML servlet validates the request message to ensure it conforms to a document type definition associated with the particular type of request. Once validated, the request message is parsed and converted into a document object model for processing by processes within the biller manager. The XML servlet directs the modeled request message to a designated biller manager process designed to handle such requests. The designated biller manager process produces a response message which is passed to a transformer after being parsed through another document object model. The transformer checks the transformer tag included in the request message associated with the response message and uses this tag to transform the response message into a format required by the requesting entity. The response message is then made available to the requesting entity in the required format, thus allowing the entity to view the requested information using the same device or software used to generate the request message.

Additional aspects of the invention will be set forth in part in the description which follows, and in part will be obvious from the description, or may be learned by practice of the invention. It is to be understood that both the foregoing general description and the following detailed description are exemplary and explanatory only and are not restrictive of the invention, as claimed.

### BRIEF DESCRIPTION OF THE DRAWINGS

The accompanying drawings, which are incorporated in and constitute a part of this specification, illustrate several embodiments of the invention and together with the description, serve to explain the principles of the invention. In the drawings,

FIG. 1 illustrates an exemplary system environment in which features and principles consistent with the present invention may be implemented;

FIG. 2 illustrates an exemplary biller manager configuration consistent with features and principles of the present invention;

FIG. 3 illustrates an exemplary flowchart for processing requests consistent with features and principles of the present invention;

FIGS. 4A, 4B and 4C illustrate exemplary XML formats associated with requests, DTDs and response messages, respectively, consistent with features and principles of the present invention;

FIG. 5 illustrates an exemplary XML servlet configuration, consistent with features and principles of the present invention; and

FIG. 6 illustrates an exemplary flowchart showing exemplary processes performed by the XML servlet, consistent with features and principles of the present invention;

### DETAILED DESCRIPTION

Methods, systems and articles of manufacture consistent with the present invention enable an EIPP system to integrate with a wide variety of systems and services. In one implementation consistent with the invention, a requesting entity accesses resources provided by a server associated with the EIPP system to obtain billing data. The requesting entity selects a particular type of request offered by the server. In another aspect of the invention, the server transforms the request into a request message recognizable by a billing manager operating within the EIPP system. The request message may include, among other things, a transformation tag indicating the type of response message that is be provided by the biller manager. The request message is analyzed to determine its particular type, such as XML, Wireless Markup Language (WML), and Hypertext Markup Language (HTML) message types. XML/HTML request messages are passed to an XML servlet while requests that are not XML/HTML messages, such as a WML type message, are passed to a particular servlet for conversion into XML format before being passed to the XML servlet.

The XML servlet validates and parses the XML request message. Subsequently, the validated request message is directed to a designated biller manager process that is dedicated to handling the type of request selected by the requesting entity. Once response data is received from the biller manager process, the XML servlet consults the transformation tag associated with the request message. The XML servlet transforms the response message to the appropriate message type associated with the requesting entity based on the transformation tag. The transformed response message is then made available to the requesting entity.

Methods, systems and articles of manufacture consistent with the present invention enable any type of device or software, such as cell phones and browsers, to request information from the biller manager. Accordingly, features and principles of the present invention allow requesting entities to obtain information from the biller manager without being confined to conventional communication protocols that require compatibility between the message type produced by requesting entities and those generated by the biller manager.

Reference will now be made in detail to the exemplary embodiments of the invention, examples of which are illustrated in the accompanying drawings. Wherever possible, the same reference numbers will be used throughout the drawings to refer to the same or like parts.

In the B2C space, electronic business transactions usually involve a single purchaser of goods and services for a single business entity. In the B2B space, however, complex relationships exist between various departments, divisions, units, and, in the case of large conglomerates, even completely separate businesses. This complexity is a contributing factor in the high cost of processing electronic transactions between businesses.

To help reduce the cost of certain transaction, such as invoice processing, businesses employ the services of EIPP systems, which facilitate electronic invoice processing between businesses. Businesses provide and request business related information to and from the EIPP system. Accordingly, the higher the number of customers an EIPP system obtains, the harder it is to maintain an efficient method of processing their requests.

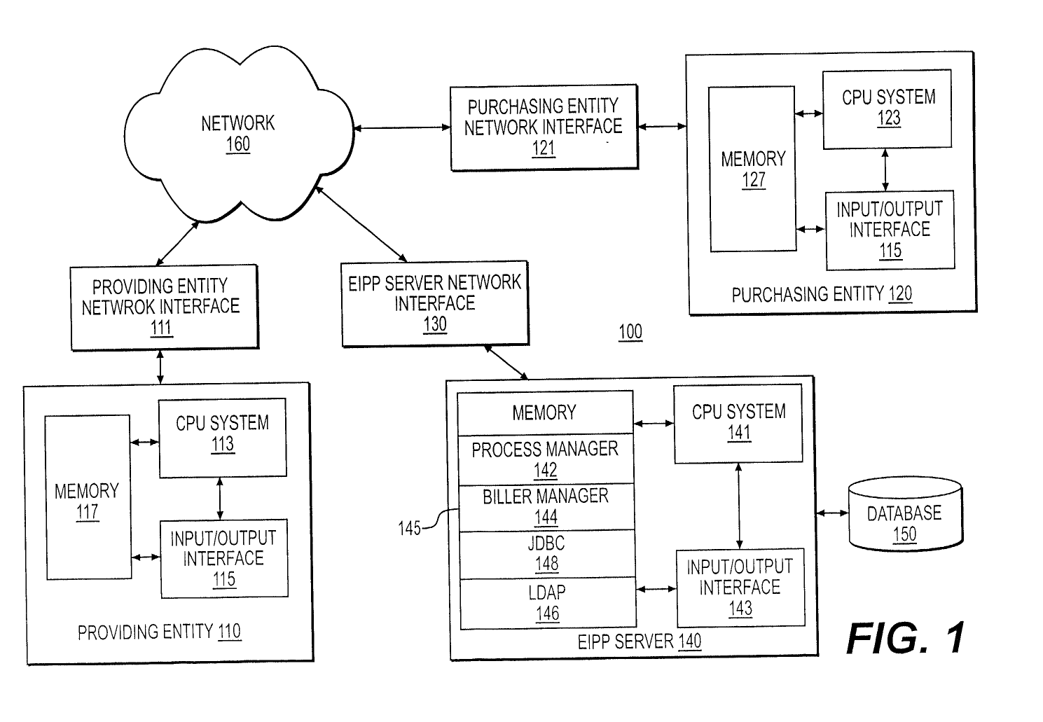

FIG. 1 shows an exemplary system environment 100 in which features and principles consistent with the present invention may be implemented. As shown, system environment 100 includes network 160, providing entity 110, purchasing entity 120, and EIPP server 140. Also depicted in FIG. 1 are network interfaces 111, 121 and 130 that may connect their respective entities (and systems) to a network 160, such as the Internet. The interfaces may be part of or, as depicted, separate from providing entity 110, purchasing entity 120 and EIPP server 140, respectively. Although FIG. 1 shows only one providing entity and purchasing entity, it is understood that any number of purchasing entities may be associated with one or more providing entities that may operate in accordance with the following description of providing entity 110 and purchasing entity 120. Furthermore, system environment 100 may include a plurality of EIPP servers 140 that collectively perform the B2B EIPP features consistent with the present invention.

Providing and purchasing entities 110, 120, and EIPP server 140, each may be implemented using virtually any type of computer system. For example, as shown in FIG. 1, providing entity 110, purchasing entity 120 and EIPP server 140 each may respectively include: a CPU system 113, 123, 141; an associated memory 117, 127, 145; and an input/output interface 115, 125 and 143. Providing entity 110, purchasing entity 120, and EIPP server 140 may also include a number of other elements and functionalities (not shown) found in today's computer systems. Providing entity 110, purchasing entity 120 and EIPP server 140 may each have associated with it an input means such as a keyboard and/or mouse (not shown). Also, entities 110 and 120, as well as EIPP server 140, may also include an output device such as a display, that may generate graphical representations through the use of an application executed by their respective CPU systems. These input and output means may take other forms as well without departing from the scope of the invention. The application may be a browser such as Netscape Communicator or Microsoft Internet Explorer.

Providing entity 110 may represent a business entity that generates bills for its customers in the form of invoices. Associated with providing entity 110, may be personnel that handle particular aspects of the billing process. The billing personnel may include, but are not limited to: a system administrator who may administer system components (such as database controls, etc.); a company administrator who may manage access to the system and may also perform other business functions such as loading invoice data into the system; and dispute handlers who handle disputes from purchasing entities, such as purchasing entity 120, associated with the invoices generated by providing entity 110A.

Purchasing entity 120 may represent a business that orders goods and/or services from providing entity 110. Associated with purchasing entity 110 may be personnel that handle particular aspects of a payment process corresponding to invoices produced by providing entity 110. The payment processing personnel may include, but is not limited to: a company administrator who manages user, company and organization information; approvers who are assigned invoices for approval; and payers who are authorized to pay invoices for purchasing entity 120.

In one implementation consistent with of the invention, EIPP server interface 130 may include a web server (not shown) that acts as a proxy for requests that are received from providing and purchasing entities 110, 120, respectively, and passes the requests to EIPP server 140 for processing. The web server may also participate in dynamic load balancing operations when system 100 is implemented with multiple EIPP servers. In such an environment, incoming requests are received at the web server and a load balancing system may direct each request to an EIPP server that is determined to be the one best suited to process it. The types of load balancing that may be implemented include, but is not limited to: server load, response time, round robin and weighted round robin mechanisms. A web server that may be used for his purpose may be the iPlanet™ web server developed by iPlanet, a Sun Microsystems, Inc. and Netscape™ alliance.

EIPP server 140 performs the B2B EIPP functions with features and principles consistent with the present invention. As shown in FIG. 1, the memory 145 contained within EIPP server 140 may include multiple processes that perform functions consistent with features of the present invention. These processes may include, but are not limited to: a process manager 142, a biller manager 144, LDAP process 146 and Java Database Caller JDBC 148. EIPP server 140 may provide dynamic load balancing (working with the web server) and failure recovery. EIPP server 140 may be implemented with a plurality of servers that facilitate fault tolerant operations. In the event one server fails, another server may take over to handle the requests previously processed by the failed server. EIPP server 140 may also implement automatic application restarting and maintain and replicate distributed user-session information and distributed application-state information. In this manner, information may be maintained as long as more than one server installation is running in a cluster with the server that failed.

EIPP server 140 may be configured as a high performance, multi-threaded and multi-processing application server. EIPP server 140 may handle a high number of concurrent requests, database connections, user sessions, and provide optimal performance under heavy loads through the use of: (1) database connection caching that enables EIPP server 140 to cache database connections so that common database connections are reused instead of reestablished; (1) result caching that enables EIPP server 140 to cache the results of application logic so that if the same request is made again, the results in the cache may be used; (3) data streaming that enables the EIPP server 140A to stream back results to the user as the data is returned instead of waiting for the entire response to complete; and (4) multi-threaded capabilities that enable application logic within EIPP server 140 to be processed on multiple threads, thus allowing the application to maximize CPU resources.

Collectively, interface 130, EIPP server 140 and database 150 maybe configured as a Java 2 Platform, Enterprise Edition (J2EE). The J2EE platform comprises of a set of services, application programming interfaces (APIs) and protocols for developing web-based applications. For more information on the J2EE platform, see Steven Gould, Develop N-Tier Applications Using J2EE, An Introduction to Java 2 Platform, Enterprise Edition Specification by Way of BEA's WebLogic Server, JavaWorld, (December 2000) <www.JavaWorld.com/javaworld/jw-12-2000/jw-1201-weblogic_p.ht>.

Process manager 142 is a workflow process that manages the routing of workflow through a predefined process. Biller manager 144 works with process manager 142 for invoice approval routing, dispute handling, enrollment process and invoice data distribution. Process manager 142 manages data that pertains to the current state of items in a given workflow process. This includes: (1) where an invoice is in an approval process; (2) the identification of a currently assigned approver for particular invoices; (3) the current state of a user enrollment process; and (4) the history of approvals within the processes. Process manager 142 may maintain a history (or log) database (not shown). The history database may include information that corresponds to each item in every invoice managed by the EIPP server 140. The history database may be updated each time a change to an invoice or individual item within an invoice is made. Process manager 142 may be configured as a cluster of Enterprise JavaBeans (EJBs) from Sun Microsystems, Inc. of Palo Alto, Calif. Enterprise JavaBeans are reusable software components that may be manipulated visually in a builder tool. The EJBs include interfaces that (1) define how the EJB may be created or destroyed; (2) define methods that may be invoked on a bean; and (3) a bean class that may implement a main business logic. Clients and EIPP server 140 may utilize the EJBs to create and edit workflow processes consistent with features of the present invention.

Biller manager 144 is responsible for managing the data access and data manipulation of the invoice data within system environment 100. Particularly, biller manager 144 manages access to any and all business data with respect to invoice data as well as customer information. This data includes: (1) invoice summary data; (2) invoice item detail data; (3) item status (currently in dispute, approved, etc.); (4) invoice payment information; (5) payment history; (6) customer account information; and (7) customer profile information. As with process manager 142, biller manager 144 may also be configured as EJBs.

JDBC process 148 interacts with database 150 and EIPP server 140 to facilitate database transactions. Database 150 may store information associated with the invoice information provided by providing entity 110. Database 150 may house tables including data corresponding to items within one or more invoices generated by providing entity 110, and departments associated with purchasing entity 120. Database 150 may also store information that is used by biller manager 144 and process manager 142 to facilitate the approval/dispute processing features consistent with the present invention. Furthermore, database 150 may also store payment information associated with items for each invoice and process state information associated with workflow processes that are executed by EIPP server 140. Database 150 maybe configured as an Oracle database system.

Both process manager 142 and biller manager 144 use JDBC 148 to access database 150 for data storage and access. JDBC process 148 may be implemented as a set of APIs that provide platform independent access to databases, such as database 150. Biller manager 144 and process manager 142 each contain all of the business logic needed for a solution associated with an invoice problem. Process manager 142 and biller manager 144 each access their own particular data. For instance, biller manager 144 may only directly access business data, while process manager 142 may only access process state information. When process manager 142 requires access to the business data, for example to display invoice data, it communicates directly with biller manager 144 to retrieve the required information from database tables stored within database 150. Process manager 142 may not directly access data that is managed by biller manager 144, and conversely, biller manager 144 may not access data managed by process manager 142.

LDAP process 146 allows EIPP server 140 to communicate with a configuration LDAP server and a User & Group (U& G) LDAP server (not shown). These LDAP servers store data (entries) in a hierarchical manner and include attributes describing information about the entries. Relationships between the entries may be inferred by strategic placement of the entries in the hierarchy. Accordingly, the configuration and U & G LDAP servers allow efficient retrieval of information through the use of the attributes and the hierarchy. The configuration LDAP server may store information that EIPP server 140 needs for operation. This information may include, for example, database configuration information and process manager application definitions. The U & G LDAP server may store information about all of the users and groups associated with EIPP server 140. It may also store information about purchasing entity's 120 organizations and the people responsible for approving invoices (approvers). Methods, and systems consistent with the present invention use XML to integrate communication between various customers and EIPP server 140. The present invention utilizes a defined XML format for invoice, customer profile and business hierarchy structures. This information is assembled using the defined format and then is loaded into EIPP server 140 using a loading program.

The automated process of converting a company's billing data format to the defined XML data structure implemented by EIPP server 140 may be performed by a servlet operating within biller manager 144. The servlet uses mapping technology to transform one data format to another, through the definition of data maps. The servlet then outputs properly formatted XML files ready for loading and use by the biller manager 142. Also, billing data that is managed by EIPP server 140 is made available to requesting entities, such as purchasing and providing entities 110,120, by the servlet in formats compatible with these entities.

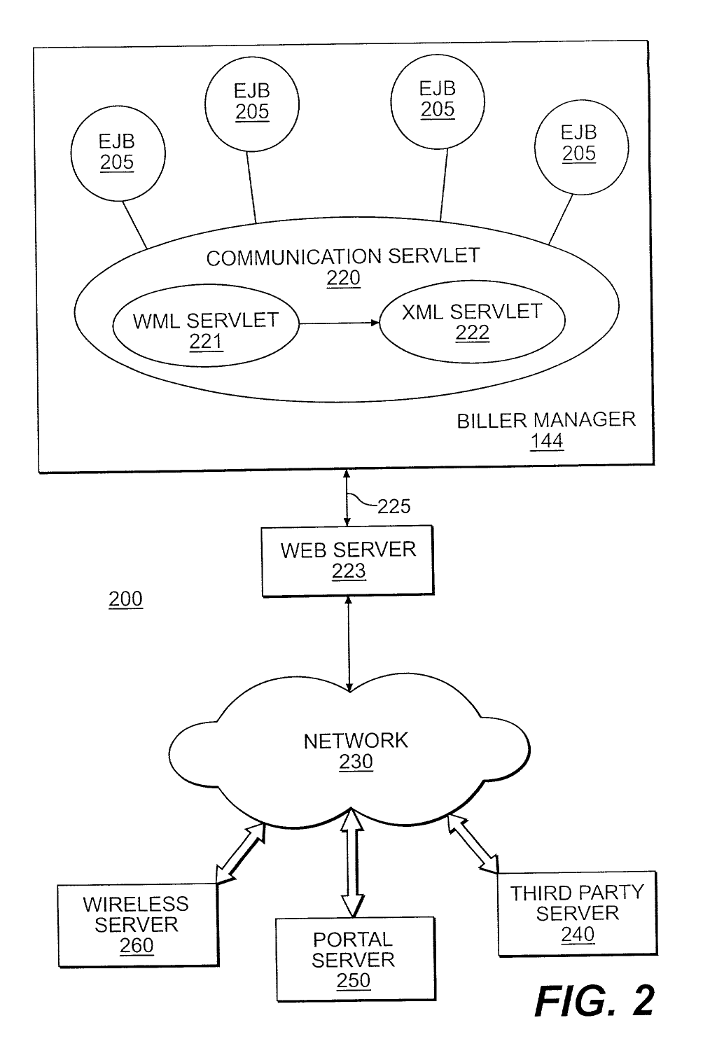

FIG. 2 illustrates an exemplary integration environment with features and principles consistent with the present invention. As shown in FIG. 2, system environment 200 includes biller manager 144 connected to a web server 223. Web server 223, in turn is connected to network 230. Also connected to network 230 are various servers, including third party server 240, portal server 250 and wireless server 260. Although FIG. 2 shows three types of servers (240, 250 and 260), any number of various types of servers may be employed without departing from the scope of the present invention.

Biller manager 144 operates within EIPP server 140 (not shown in FIG. 2) as previously illustrated in FIG. 1, and includes EJBs 205 and communication servlet 220. EJBs 205 may represent the EJBs that make up the biller manager 144 and perform the B2B management functions previously discussed, such as handling request messages from customers. The EJBs 205 communicate with communication servlet 220 that is an integration component that performs the XML conversion process.

Servlet 220 may be a program written in the Java™ programming language that extends the functionality of a web server. Similar to a Common Gateway Interface (CGI), servlet 220 may be executed dynamically upon request. Unlike a CGI, however, servlet 220 may be executed as a separate thread by biller manager 144 thus offering more scalability in their use than a CGI. Consistent with principles of the present invention, servlet 220 includes, among other things, two servlets, namely a WML servlet 221 and an XML servlet 222. Request messages received at web server 223 are directed to servlet 220. Request messages in WML format are directed to WML servlet 221 for transformation into an XML format, while HTML and XML type messages are directed to XML servlet 222. The WML messages that are transformed to XML are similarly directed to XML servlet 222 for processing.

XML servlet 222 accepts requests for information from web server 223, or WML servlet 221, through a defined XML format, and responds back in required formats, including XML, HTML, and WML, via communication path 225. The messages are sent back to the appropriate requesting entity, that may employ the services of third party server 240, portal server 250, and wireless server 260.

Communication servlet 220, WML servlet 221 and XML servlet 222 are exemplary only and are not intended to be limiting. That is, processes other than servlets may be implemented to perform the same functions, without departing from the scope of the present invention.

Web server 223 may be any standard web-based platform that provides web services to customers connected to network 230. In one aspect of the invention, web server 223 maintains resources, such as web sites, that are available to the customers. A requesting entity (customer) may access the web resource provided by web server 223 to gain access to billing data that is managed by biller manager 144 and EIPP server 140.

Third party server 240 may be a server system that provides direct access to a business entity. This may include Internet Service Provider (ISP) servers or any other type of server, such as a Sun Solaris™ system, that may be configured to exchange information between EIPP server 140 and a particular business entity.

Portal Server 250 provides a secure web environment for the B2B EIPP system consistent with features of the present invention. It enables the EIPP server 140 to share content data with billing and buying companies by providing a URL that allows these companies to receive information associated with their companies. Portal server 250 in a sense simulates a virtual private network (VPN) over network 230 to provide secure sessions for customers. Portal server 250 may not require customers to utilize intermediary servers, or client configurations or setup. Accordingly, customers may directly access web server 223 through portal server 250.

Wireless Server 260 may be a server that enables wireless service providers and enterprises to provide the features facilitated by the B2B EIPP system consistent with the present invention. Wireless server 260 may deliver content data from EIPP server 140, and biller manager 144, to mobile devices, including cell phones, that are compatible with Wireless Application Protocols (WAP). The architecture of the wireless server 260 may be capable of handling a variety of wireless environments and markup languages such as WML, Handheld Device Markup Language (HDML) and HTML.

Network 230 may be any form of network capable of facilitating communications between remote entities, such as biller manager 144 and servers 240-260. A non-limiting list of data networks includes Intranets, Extranets, Virtual Private Networks, and the Internet.

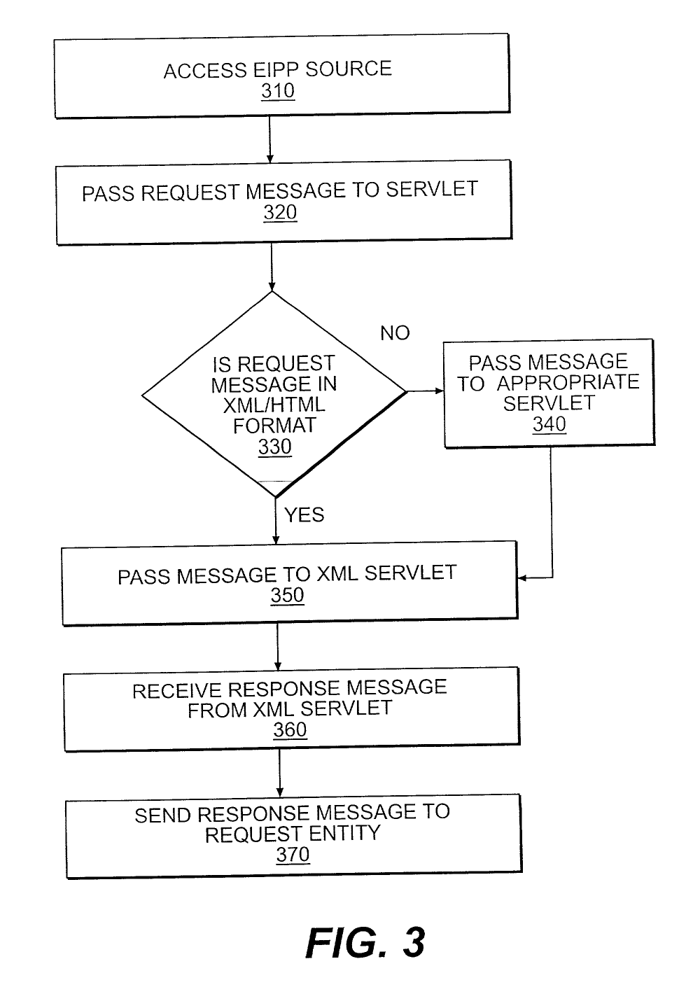

Methods and systems consistent with the present invention enable requesting entities to gain access to billing data from EIPP server 140 by accessing web server 223 to obtain billing data in a particular format that is compatible with the requesting entity's respective configuration. FIG. 3 illustrates an exemplary flowchart describing features and principles consistent with the present invention implemented in system environment 200.

A requesting entity, at any time, may desire to gain access to particular billing data associated with an EIPP account managed by EIPP server 140. Consistent with the principles of the invention, the requesting entity accesses a resource provided by web server 223 using any type of device and/or software available to gain access through network 230 (Step 310). The request message may be generated in any appropriate format associated with the requesting entity. For example, a user associated with a requesting entity, such as providing entity 110, may request customer profile information from EIPP server 140 using a handheld communication device, such as wireless phone with Internet access capabilities. In this case, the user's device would gain access to the resource using Wireless Access Protocol (WAP) and WML messages. Alternatively, a requesting entity may access the resource through portal server 250, using HTML or XML type messaging. Features and principles consistent with the present invention do not restrict the type of device and or software used by a requesting entity to gain access to the resource, and ultimately the billing data.

Once the requesting entity gains access to the resource, particular types of billing data may be requested. Web server 223 may provide various types of information that is available to the requesting entity, including, but not limited to, profile information, customer account information, and billing summary information. Web server 223 may also provide various editing capabilities associated with the billing data, such as adding, deleting and modifying particular types of billing data.

Once the requesting entity has determined the type of request is wishes to initiate by, for example, selecting links or menu icons provided on a web page provided by web server 223, a request message is generated and passed to communication servlet 220 over communication path 225 (Step 320). Communication servlet 220 directs the request message to either WML servlet 221 or XML servlet 222 depending on the type of device or software used by the requesting entity to initiate the request message (Step 330). Alternatively, web server 223 may direct the request message to either WML servlet 221 or XML servlet 222.

WML messages are passed to WML servlet 221 for transformation into XML format (Step 340). Transformation of the WML messages to XML are performed using standard markup language coding techniques known in the art. XML and HTML type messages are passed directly to XML servlet 222 for processing (Step 350). It should be noted that although FIG. 2 shows only a WML servlet complimenting the XML servlet, other servlets may be incorporated to handle a variety of types of message format. These servlets would also transform a request message to XML format for processing by XML servlet 222.

Once the request message is received by XML servlet 222, the request message is processed by XML servlet 222 and passed to biller manager 144. Biller manager 144 processes the request and produces a response message that is provided to XML servlet 222. The response message is transformed into the appropriate format associated with the requesting entity and sent to web server 223 (Step 360). Web server 223 then sends the response message top the requesting entity through network 230 (Step 380).

As described, methods and systems consistent with the present invention enable requesting entities to request data from biller manager 144 without being restricted to a particular type of device or software. The key to this mechanism is the ability for XML servlet 222 to include in the request message the type of response message that is required by the requesting entity.

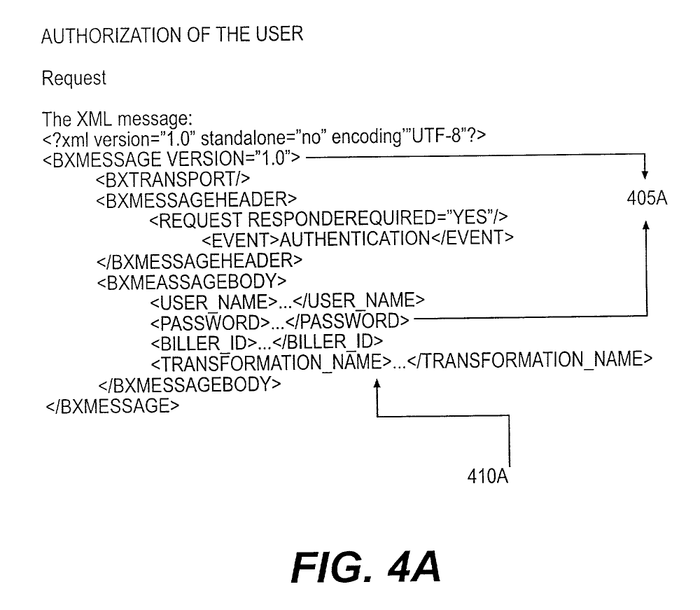

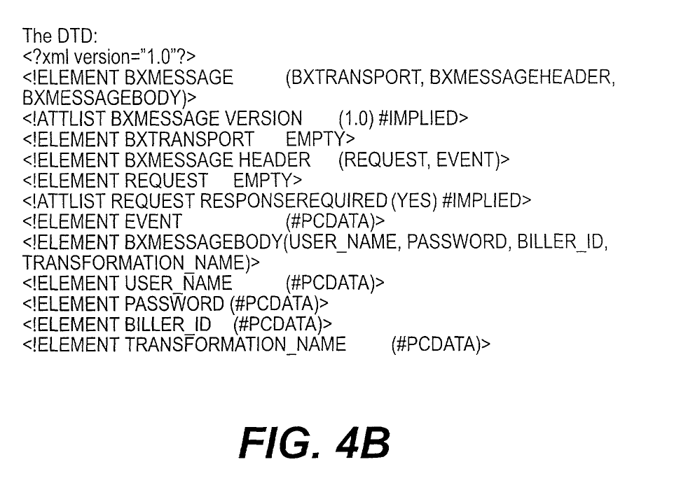

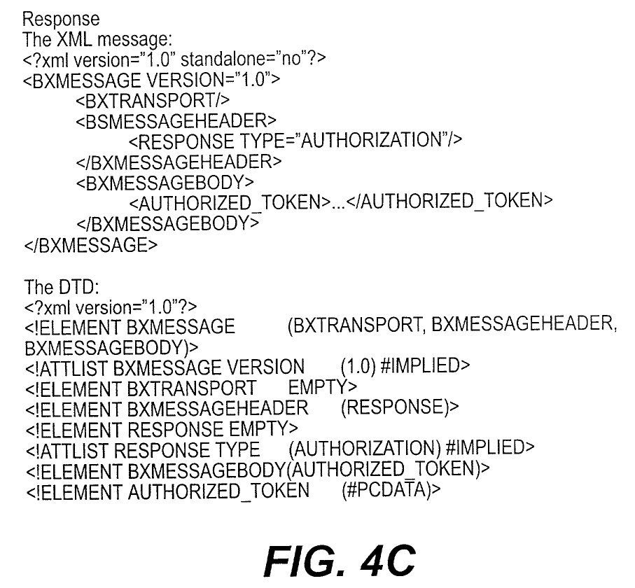

All XML request messages, whether they were transformed by WML servlet 221, or provided directly by web server 223, are received by XML servlet 222 in a particular XML format depending on the type of request. This structure enables XML servlet 222 to more efficiently transform the request into a format that biller manager 144 can recognize. Another advantage to the standardized format of request messages is that the type of response message required by a requesting entity may be designated within the request message. This may be performed through the use of transformation tags included within the XML request message format. FIG. 4A illustrates an exemplary XML request message format 400A associated with the authorization of a user. As shown in FIG. 4A, XML description 400A includes a variety of tags 405A associated with the authorization request. Also included within XML message format 400A are transformation tags 410A that indicate the type of format a corresponding response message should be sent. XML servlet 222 uses the transformation tags to produce a response message that is compatible with the requesting entity's device or software used to generate the request message.

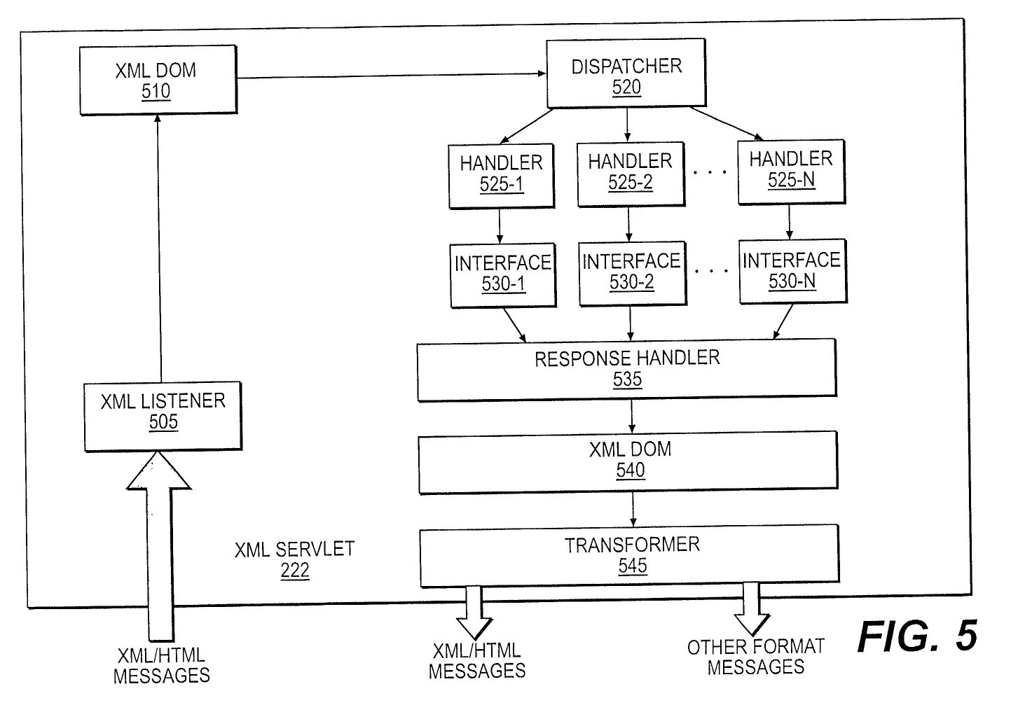

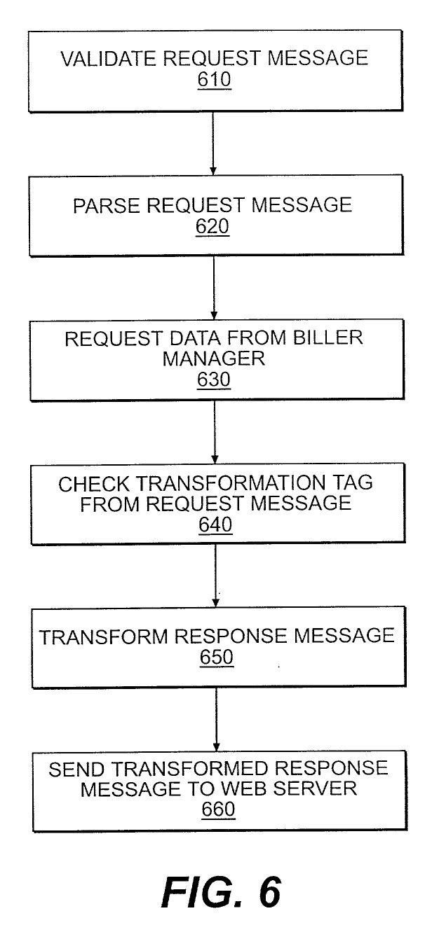

To better understand the features and principles of the present invention, FIGS. 5 and 6 illustrate an exemplary block diagram of, and processes performed by, XML servlet 222, respectively. As shown in FIG. 5, XML servlet 222 may include XML listener 505, input XML Document Object Manager (DOM) 510, dispatcher 520, handlers 525-1 to 525-N, biller manager interfaces 530-1 to 530-N, response handler 535, output XML DOM 540 and transformer 545.

XML listener 505 is a process that receives all requests that originated at a requesting entity and forwarded by web server 223, as well as those messages transformed by WML servlet 221, or any other servlet implemented by the present invention. The requests may be associated with, but are not limited to, invoice summary information, invoice details and user profile information. XML listener 405 may utilize validation logic that verifies the XML request message structure (Step 610). Because of the need for standardized formats for particular types of request messages (such as customer profile, billing summary data, etc.) validation logic ensures that the structure of the request message associated with a particular type of message is correct, to ensure biller manager 144 understands the request prior to processing it.

The request messages received by XML servlet 222 may be defined by Document Type Definitions (DTDs). DTDs define element types, attributes, entities and notations within a particular document. A DTD of a document specifies which of these element characteristics are valid within the document and the locations they are valid. A document may claim to conform to a specific DTD based on a document Type Definition (DOCTYPE). A document with a DTD that is narrowly defined may limit particular types of information within a specific location of the document, such as a form document. The validation logic implemented by XML listener 505 ensures that the converted XML request messages each conform to defined DTDs. In other words, the validation logic ensures that the XML request messages used by XML servlet 222 include data that is in the correct locations, context and comprises correct information. Invalid request messages may be denied processing by XML servlet 222, while valid documents are presented to XML DOM 510 for further processing. FIG. 4B illustrates an exemplary DTD for the request message shown in FIG. 4A.

XML DOM 510 is an application programming interface used for XML and HTML information. Document Object Models are known in the art, and XML servlet 222 implements the known features of a DOM to facilitate the conversion of incoming requests to the XML format utilized by biller manager 144. More information on DOMs may be found in Charles F. Goldfarb, The XML Handbook, 640-44 (Prentice Hall PTR) (2001). The request messages generated by requesting entities may be associated with documents of information (such as billing summary data) that are managed by the B2B EIPP system, particularly biller manager 144. The XML DOM 510 defines the logical structure of these documents and the manner by which they are edited and accessed. The logical structure of B2B document data is modeled using objects. This structure, or model, enables XML servlet 222 to identify interfaces and objects used to represent and modify a document; the behavior and attributes of these interfaces and objects; and any relationships between the interfaces and object.

In creating an object model, the request messages are parsed by a parser operating within the XML DOM 510 (Step 620). The parser may be an event-based parser or API such as Simple API for XML (SAX). For more information on SAX, see Charles F. Goldfarb, The XML Handbook, 640-44 (Prentice Hall PTR) (2001). XML DOM 510 processes the parsed request messages to create an object model corresponding to the information included within the request messages. This process allows XML servlet 222 to recognize how the messages are represented as objects, thus enabling object-oriented programming to be used to complete conversions to XML formats implemented by biller manager 144.

Once the parsed request messages are appropriately modeled by DOM 510, manipulations of the data included in the request messages may be performed. Parsed transformation tags may be separated from the other information in the request messages and stored for future use when a response message is generated. Following the generation and use of object models from XML DOM 510, XML servlet 222 passes the objects to dispatcher 520.

Dispatcher 520 determines the type of request or information sought based on the objects modeled after the request messages, and directs this information to an appropriate handler (525-1 to 525-N) for processing. Handlers 525-1 to 525-N are dedicated processes that may be designed to handler particular types of requests.

Once a particular handler has received a request, it is passed to an appropriate biller manager EJB 205 that is configured to process the request (Step 630). Handlers 525-1 to 525-N pass the requests to biller manager EJBs 205 through biller manager interfaces 530-1 to 530-N that are dedicated interfaces for the above mentioned biller manager EJBs 205. EJBs 205 process the requests and produce response messages that include the appropriate information designated in the requests. These responses may include producing bill summary information, user profile information or any other form of data associated with the information managed by biller manager 144. Alternatively, methods and systems consistent with the present invention may implement a single handling process that interfaces with billing manager EJBs 205. The configuration of handlers 525-1 to 525-N and interfaces 530-1 to 530-N are not limiting. That is, a variety of configurations may be employed by XML servlet 222 to communicate with billing manager 144 to obtain response data.

Once an appropriate EJB 205 within biller manager 144 has generated response data associated with the request messages, the response data is passed to response handler 535. The response handler 535 collects all generated outputs from biller manager 144. Response handler 535 may be designed to handle multiple responses simultaneously, thus increasing the throughput efficiency of XML servlet 222. Response handler 535 converts the response data to an XML response message in a format associated with the type of request indicated by the requesting entity through web server 223. The response messages are then passed to an output XML DOM 540. XML DOM 540 may operate similar to XML DOM 510 in order to redefine responses into object models for use by transformer 545.

Transformer 545 may be an eXtensible Stylesheet Language Transformer (XSLT). XSLT is a part of the eXtensible Stylesheet Language (XSL) which is used for expressing stylesheets. XSLT is used for transforming XML documents and includes the use of an XML vocabulary that specifies how documents are formatted. XSL uses XSLT to style an XML document to define how the document is transformed into another XML document compatible with the format specified by the XML vocabulary. XSLT may also be used to transform an XML document into other types of documents, such as HTML documents.

Stylesheets describe how documents are presented on screens or printed. XML servlet 222 uses stylesheets to influence how documents, such as invoice documents in XML or HTML formats, are presented. Transformer 545 may use XSLT techniques to create output data in the appropriate format compatible with the requesting entity. Prior to doing so, however, XML servlet 222 must determine what type of format to transform the response message into.

Consistent with features and principles of the present invention, transformer 545 accesses the transformation tag previously included in the request message that initiated biller manager 144 to produce the respective response message (Step 640). The transformation tag may be collected from storage where it was previously housed by XML DOM 510. Once transformer interprets the transformation tag associated with the response message, the appropriate XSL is applied to the response message to convert the message into a format compatible with the requesting entity that generated the corresponding request message (Step 650). For instance, transformer 545 may output the response data as an XML document for use by an XML compatible requesting entity. Alternatively, transformer 545 may produce HTML response data for a requesting entity that utilizes this type of markup language. Other formats may be compatible as well, such as WML for wireless services, which may be directed to wireless server 260, as shown in FIG. 2. As a default, XML servlet 222 may send response messages that include transformation tags that are unrecognizable (or missing) in HTML format. FIG. 4C illustrates an exemplary XML response message format and corresponding DTD associated with the request message shown in FIG. 4A.

After the response messages are transformed, they are sent to web server 223 to be made available to the requesting entity through the web resource (Step 660).

As described, systems and methods consistent with features of the present invention enable requesting entities to access information from a server system without considering the type of device or software used to access the server system to request the information. The foregoing description of an implementation of the invention has been presented for purposes of illustration and description. It is not exhaustive and does not limit the invention to the precise form disclosed. Modifications and variations are possible in light of the above teachings or may be acquired from practicing of the invention. For example, the described implementation includes software but the present invention may be implemented as a combination of hardware and software or in hardware alone. Furthermore, the invention is not limited to EIPP type systems, but rather may be implemented within any network environment that utilizes request and response messages consistent with features and principles of the present invention. The invention may also be implemented with both object-oriented and non-object-oriented programming systems. Additionally, the type of configurations illustrated in the drawings and described above are not intended to be limiting. That is, any number of configurations may be utilized to without departing from the scope of the present invention.

Moreover, the types of XML formats illustrated in the drawings and described above are not limiting. The versatility in the present invention is that any type of formats may be defined and implemented within a communication servlet to process request messages in accordance with features and principles of the present invention. For example, Appendix A shows a number of exemplary XML formats for request and response messages that may be utilized by methods and systems consistent with the present invention. Additional formats may be added, or deleted based on the application of the present invention.

Furthermore, although aspects of the present invention are described as being associated with data stored in memory and other storage mediums, one skilled in the art will appreciate that these aspects can also be stored on or read from other types of computer-readable media, such as secondary storage devices, like hard disks, floppy disks, or CD-ROM; a carrier wave from the Internet; or other forms of RAM or ROM. Accordingly, the invention is not limited to the above described embodiments, but instead is defined by the appended claims in light of their full scope of equivalents

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

What is claimed is:

1. A method for processing requests for information in an electronic invoice presentment and payment system including at least a requesting entity and a server system interconnected by a network, the method comprising:
receiving a request configured in a first format at the server system, wherein the request includes a tag that indicates a response format associated with the requesting entity;
generating a response associated with the request;
transforming the response to the response format based on the tag; and
making the transformed response available to the requesting entity.

2. The method of claim 1, wherein the first format and the response format are identical.

3. The method of claim 2, wherein the request was initiated by the requesting entity through the network.

4. The method of claim 1, wherein the tag indicates a type of XSL conversion and transforming the format of the response comprises:
using the type of XSL conversion indicated in the tag to convert the response to the first format.

5. The method of claim 1, wherein receiving a request comprises:
making request types available to the requesting entity;
receiving a selection of a request type from the requesting entity; and
generating the request configured in the first format based on the selection and the requesting entity.

6. The method of claim 1, wherein receiving a request comprises:
determining whether the request is in XML format; and
converting the request to a particular XML format in the event the request is not in XML format.

7. The method of claim 6, wherein the particular XML format is based on a type of the request.

8. The method of claim 7, wherein the requesting entity is associated a user and the type of the request includes at least one of a request for billing summary information, a request for authorization of the user, a request for user account information, a request to make a payment associated with an invoice, a request to view user profile information, and a request to edit user profile information.

9. The method of claim 1, wherein generating a response comprises:
requesting information from a process operated by the server system based on the request;
receiving the information from the process; and
generating the response based on the information in XML format.

10. The method of claim 9, wherein transforming the format of the response comprises:
transforming the response from the XML format to the first format based on the analysis.

11. A method for processing a response message associated with a request message corresponding to a requesting entity in an electronic invoice presentment and payment system, comprising:
receiving a response message in a first format;
converting the response message to a second format based on an indicator included in the request message; and
sending the converted response message to the requesting entity such that the second format is the same format as that of the request message.

12. The method of claim 11, wherein the indicator identifies a type of XSL conversion that is to be applied to the response message.

13. The method of claim 11, wherein the request message is formatted in XML and the indicator is a tag embedded in the request message.

14. The method of claim 13, wherein the requesting entity initiates the request message by accessing a resource through a request formatted in the second format.

15. The method of claim 13, wherein the requesting entity initiated the request message by accessing a resource in the second format, and wherein the second format is not formatted in XML.

16. An electronic invoice presentment and payment system for processing request messages, comprising:
a requesting entity for generating a first request in a first format;
a web server for receiving the first request and generating a first request message in a second format based on the first request; and
a servlet for receiving the first request message, determining a format for a response message based on an indicator included in the first request message, validating the first request message, requesting data from a server process based on the first request message, receiving response data from the server process, converting the response data into a response message in the second format; transforming the response message to the first format based on the determined format for the response message.

17. The system of claim 16, wherein the servlet operates within a billing manager configured to manage electronic invoice presentment and payment operations associated with the requesting entity.

18. The system of claim 16, wherein the first format is one of XML, HTML and WML and the second format is XML.

19. The system of claim 16, wherein the servlet includes a WML servlet for receiving request messages in WML format, converting received WML formatted request messages to XML format, and sending the converted XML format request messages to an XML servlet included within the servlet.

20. The system of claim 16, wherein the web server sends the first request message to a WML servlet operating within the servlet when the first format is WML, and sends the first request message to a XML servlet, also operating within the servlet, when the first format is one of XML and HTML.

21. The system of claim 16, wherein the second format is XML and the indicator is a transformation tag included within the request message.

22. The system of claim 21, wherein the transformation tag indicates a type of XSL conversion to be applied to the response message based on the first format of the first request, and wherein the servlet transforms the response message to the first format based on the transformation tag.

23. A servlet associated with an electronic invoice presentment and payment server for processing request messages corresponding to a requesting entity, comprising:
a listener for receiving a request message in a first format and validating the request message based on the first format;
a parser for parsing the validated request message;
a dispatcher for providing the parsed request message to a server process based on a type of the request message;
a response handler for receiving response data associated with the request message and converting the response data into a response message; and
a transformer for determining a response format for the response message based on an indicator included in the request message and converting the response message to the response format based on the determination.

24. The servlet of claim 23, wherein the first format is XML and the listener validates the XML request message against a DTD.

25. The servlet of claim 23, wherein the first format is XML and the indicator is a tag included within the XML request message.

26. The servlet of claim 25, wherein the tag indicates a type of XSL conversion to be applied to the response message and the transformer converts the response message to the response format based on the tag.

27. The servlet of claim 26, wherein the response format is a format associated with the requesting entity that initiated the request message.

28. A method for processing request messages corresponding to a requesting entity, the method performed by a servlet operating within an electronic invoice presentment and payment server comprising:
receiving a request message in a first format;
validating the request message based on the first format;
parsing the validated request message;
providing the parsed request message to a server process based on a type of the request message;
receiving response data associated with the request message and converting the response data into a response message;
determining a response format for the response message based on an indicator included in the request message; and
converting the response message to the response format based on the determination.

29. The method of claim 28, wherein the first format is XML and validating the request message comprises:
validating the XML request message against a DTD.

30. The method of claim 28, wherein the first format is XML and the indicator is a tag included within the XML request message.

31. The method of claim 30, wherein the tag indicates a type of XSL conversion to be applied to the response message and converting the response message comprises:
converting the response message to the response format based on the tag.

32. The method of claim 30, wherein the response format is a format associated with a requesting entity that initiated the request message.

33. A system for processing request messages in an electronic invoice presentment and payment system including a requesting entity and a server interconnected by a network, comprising:
a processor; and
a memory containing instructions executable by the processor to:
receive a request message in a first format, wherein the request message includes an indicator that identifies a response format for a response message associated with the request message;
determine a type of request based on the request message;
direct the request to a billing manager process based on the determination;
receive response data from the billing manager process;
convert the response data to a response message in the first format; and
transform the response message to the response format based on the indicator.

34. A system for processing request messages in an electronic invoice presentment and payment system including a requesting entity that requests invoice data from a remotely located server, comprising:
a first process for receiving a request from the requesting entity for billing management information associated with the requesting entity, and generating a request message including a tag that identifies a response message format;
a second process for utilizing the tag to transform a response message created based on the request message to the response message format; and
a third process for making the transformed response message available to the requesting entity such that the response message format is a format compatible with the requesting entity.

35. The system of claim 34, wherein the request message is an XML message and the tag identifies a type of XSL conversion to apply to the response message.

36. The system of claim 35, wherein the second process transforms the response message from an XML format to the required format based on the tag.

37. A servlet for processing request messages in an electronic invoice presentment and payment system including a requesting entity and a server interconnected by a network, comprising:
a first servlet, operating within the server, for receiving a WML request message associated with the requesting entity, and converting the WML request message to an XML request message; and
a second servlet, operating within the server, for receiving the converted XML request message from first servlet and processing the XML request message such that a tag included within the XML request message is used to transform an XML response message to a WML response message.

38. A method for processing requests for information in an electronic invoice presentment and payment system including at least a requesting entity and a server system interconnected by a network, the method comprising:
receiving a request, from the requesting entity, configured in a first format at a web server associated with the server system,
generating a request message formatted in XML, wherein the request message includes a tag that indicates a response message format associated with the requesting entity;
processing the request message to produce response data;
converting the response data into XML format;
analyzing the tag to determine a type of XSL conversion to apply to the response message;
transforming the XML response message into the response message format based on the analysis; and
making the transformed response message available to the requesting entity.

39. A computer-readable medium including instructions for performing a method, when executed by a processor, for processing requests for information in an electronic invoice presentment and payment system including at least a requesting entity and a server system interconnected by a network, the method comprising:
receiving a request configured in a first format at the server system, wherein the request includes a tag that indicates a response format associated with the requesting entity;
generating a response associated with the request;
transforming the response to the response format based on the tag; and
making the transformed response available to the requesting entity.

40. The computer-readable medium of claim 39, wherein the first format and the response format are identical.

41. The computer-readable medium of claim 40, wherein the request was initiated by the requesting entity through the network.

42. The computer-readable medium of claim 39, wherein the tag indicates a type of XSL conversion and transforming the format of the response comprises:
using the type of XSL conversion indicated in the tag to convert the response to the first format.

43. The computer-readable medium of claim 39, wherein receiving a request comprises:
making request types available to the requesting entity;
receiving a selection of a request type from the requesting entity; and
generating the request configured in the first format based on the selection and the requesting entity.

44. The computer-readable medium of claim 39, wherein receiving a request comprises:
determining whether the request is in XML format; and
converting the request to a particular XML format in the event the request is not in XML format.

45. The computer-readable medium of claim 44, wherein the particular XML format is based on a type of the request.

46. The computer-readable medium of claim 45, wherein the requesting entity is associated a user and the type of the request includes at least one of a request for billing summary information, a request for authorization of the user, a request for user account information, a request to make a payment associated with an invoice, a request to view user profile information, and a request to edit user profile information.

47. The computer-readable medium of claim 39, wherein generating a response comprises:
requesting information from a process operated by the server system based on the request;
receiving the information from the process; and
generating the response based on the information in XML format.

48. The computer-readable medium of claim 47, wherein transforming the format of the response comprises:
transforming the response from the XML format to the first format based on the analysis.

49. A computer-readable medium including instructions for performing a method, when executed by a processor, for processing a response message associated with a request message corresponding to a requesting entity in an electronic invoice presentment and payment system, the method comprising:
receiving a response message in a first format;
converting the response message to a second format based on an indicator included in the request message; and
sending the converted response message to the requesting entity such that the second format is the same format as that of the request message.

50. The computer-readable medium of claim 49, wherein the indicator identifies a type of XSL conversion that is to be applied to the response message.

51. The computer-readable medium of claim 49, wherein the request message is formatted in XML and the indicator is a tag embedded in the request message.

52. The computer-readable medium of claim 51, wherein the requesting entity initiates the request message by accessing a resource through a request formatted in the second format.

53. The computer-readable medium of claim 51, wherein the requesting entity initiated the request message by accessing a resource in the second format, and wherein the second format is not formatted in XML.

54. A computer-readable medium including instructions for performing a method, when executed by a processor, for processing request messages corresponding to a requesting entity, the method performed by a servlet operating within an electronic invoice presentment and payment server comprising:
receiving a request message in a first format;
validating the request message based on the first format;
parsing the validated request message;
providing the parsed request message to a server process based on a type of the request message;
receiving response data associated with the request message and converting the response data into a response message;
determining a response format for the response message based on an indicator included in the request message; and
converting the response message to the response format based on the determination.

55. The computer-readable medium of claim 54, wherein the first format is XML and validating the request message comprises:
validating the XML request message against a DTD.

56. The computer-readable medium of claim 54, wherein the first format is XML and the indicator is a tag included within the XML request message.

57. The computer-readable medium of claim 56, wherein the tag indicates a type of XSL conversion to be applied to the response message and converting the response message comprises:
converting the response message to the response format based on the tag.

58. The computer-readable medium of claim 56, wherein the response format is a format associated with a requesting entity that initiated the request message.

59. A computer-readable medium including instructions for performing a method, when executed by a processor, for processing requests for information in an electronic invoice presentment and payment system including at least a requesting entity and a server system interconnected by a network, the method comprising:
receiving a request, from the requesting entity, configured in a first format at a web server associated with the server system,
generating a request message formatted in XML, wherein the request message includes a tag that indicates a response message format associated with the requesting entity;
processing the request message to produce response data;
converting the response data into XML format;
analyzing the tag to determine a type of XSL conversion to apply to the response message;
transforming the XML response message into the response message format based on the analysis; and
making the transformed response message available to the requesting entity.
